(19) United States
(12) Patent Application Publication
(10) Pub. No.: US 2010/0310956 A1
(43) Pub. Date: Dec. 9, 2010

(54) Bipolar Plate for a Fuel Cell with a Polymer Membrane

(75) Inventors: David Olsommer, Le Mont Pelerin (CH); Richard Herault, Genas (FR)

Correspondence Address: COHEN, PONTANI, LIEBERMAN & PAVANE LLP, 551 FIFTH AVENUE, SUITE 1210, NEW YORK, NY, 10176, US

(73) Assignee: Michelin Recherche er Technique S.A., Grandes-Paccot (CH)

(21) Appl. No.: 12/522,670

(22) PCT Filed: Dec. 21, 2007
(86) PCT No.: PCT/EP07/11407

§ 371 Date: Aug. 30, 2010

(30) Foreign Application Priority Data
Jan. 9, 2007 (FR) 0700184

(51) Int. Cl. H01M 8/04; H01M 8/00; F27D 7/00

(52) U.S. Cl. 429/434; 429/535; 432/23

(57) ABSTRACT

A distribution plate for a fuel cell, comprising a first plate (11) made of electrically conductive material having an inner face and having an outer face (11o) adapted to cooperate with an ion-exchange membrane, the outer face (11o) comprising a network of distribution channels (111) for a first gas, the distribution plate having a second plate (12) made of electrically conductive material having an outer face and having an inner face (12i) adapted to be applied against the inner face of the first plate (11), a network of channels (122) for the circulation of a coolant being provided on the inner face either of the first plate (11) or (12i) of the second plate (12), or on both, the plates being joined by a uniform layer of an electrically conductive link material (2) covering the inner face of each of the first and second plates.

### FIELD OF THE INVENTION

The present invention relates to fuel cells with an ion-exchange polymer membrane. More particularly, it relates to the fluid distribution plates used in such fuel cells, such as, for example, the bipolar plates installed between each of the individual electrochemical cells and the end plates installed either side of the stack of the different electrochemical cells.

### STATE OF THE ART

The bipolar plates used in fuel cells fulfil two very different functions. It is known that the cell must be fed with fuel gas and oxidizing gas, that is, with hydrogen and air or pure oxygen, and it is also necessary to cool it, that is, have it pass through a coolant such as water. One of the functions of the bipolar plates is to allow the routing of these various fluids that are necessary for the operation of the fuel cell. Moreover, the bipolar plates also fulfil an electrical function: providing electrical conduction between the anode and the cathode of each of the adjacent electrochemical cells. In practice, a fuel cell always comprises a series assembly of a large number of basic electrochemical cells; the basic electrochemical cells being connected in series, the nominal voltage of the fuel cell is the sum of the voltages of each basic electrochemical cell.

These various functions, routing the fluids and conducting the electricity, define the specifications that the materials used to produce these bipolar plates must satisfy. The materials used must offer a very high electrical conductivity. The materials used must also be leakproof to the fluids used and demonstrate a very high chemical stability to these fluids.

Furthermore, the bipolar plates must have mechanical characteristics that are adequate to allow a large number of basic electrochemical cells and associated bipolar plates to be juxtaposed and for the assembly to be held by compression between the endplates using tie-rods. The bipolar plates must offer mechanical characteristics that are adequate to withstand this compression. Graphite is commonly used because this material offers both a high electrical conductivity and is chemically inert to the fluids used. Patent application WO 2005/006472 shows one possible implementation of such bipolar plates. It can be seen that they are made by the superposition of two relatively rigid graphite plates with a sheet made of fairly flexible graphite material inserted between them in order to accept the thickness tolerances of the different layers. The graphite plates include the networks of channels that are necessary to the distribution of the fuel and oxidizing gases, that is, hydrogen and air or pure oxygen, and the network of channels allowing each bipolar plate to be passed through by a coolant such as water.

Unfortunately, the rigid elements involved in the construction of the graphite bipolar plates are fairly fragile to impacts, particularly during handling when assembling the cell. The layer made of flexible graphite material, referred to previously, is also particularly difficult to manipulate industrially. All this weighs heavily on the production costs of such bipolar plates.

The U.S. Pat. No. 6,379,476 proposes to produce bipolar plates made of stainless steel covered with a surface-passivated film and having carbide inclusions protruding on the surface. According to the applicant for this patent, the proposed product should offer a contact electrical resistance that is low enough to be able to make bipolar plates of it. However, while this solution may offer some advantages compared to the bipolar plates that are entirely made of graphite, notably as to the mechanical properties, it is still complex to implement and the electrical resistivity may prove too high, above all if the aim is to achieve a very high power density for the fuel cell.

Other patent applications propose producing bipolar plates made of non-metallic material, for example of plastic material, because of the very high insensitivity of many of these materials to chemical attack from the gases used and from the coolant. Patent application WO 2006/100029 can be cited as an example.

The patent application US 2005/0100771 describes a bipolar plate for a fuel cell formed by bringing two plates into galvanic contact, each plate being formed by a metal substrate having a central conductive region, the conductive region being coated with an ultra-thin layer of conductive metal. Producing such a coating weighs on the cost of the bipolar plates.

The patent applications US 2003/0228512 and US 2005/0252892 describe a bipolar plate for a fuel cell formed from two plates, each formed by a metallic substrate having a central conductive region, the conductive region being coated with an ultra-thin layer of conductive metal, and with a third, separating plate inserted between them. Here again, the production of such a coating weighs on the cost of the bipolar plates and the proposed structure is even more complex.

And then there is patent application EP 0955686. Here again, a bipolar plate for a fuel cell is described that is formed by bringing two tin-coated stainless steel plates into galvanic contact. As already stated, the production of such a coating weighs on the cost of the bipolar plates and the electrical contact obtained depends greatly on the quality of the stacking of the elements forming the fuel cell and their ageing.

The use of metal plates as bipolar plates offers a number of disadvantages over graphite plates. The main advantage to be cited is the greater mechanical resistance of the metal which means that the thicknesses of the plates can be reduced, and the problems of plate cracking can be avoided.

On the other hand, the metal plates, notably those made of stainless steel, have electrical contact resistances that are higher than graphite plates. Consequently, the performance obtained is lower than with graphite plates or even with plates with a substrate made of plastic material, the electrical conduction being provided by add-on conductive elements. In the case of the bipolar plates made of stainless steel, the electrical ohmic losses occur at the electrical contacts:
between the gas diffusion layers (GDL) and the metal plate itself;
between the two metal plates juxtaposed to include a cooling circuit.

The aim of the present invention is to propose an arrangement for a bipolar plate or for an endplate that is as easy to manufacture as possible, that makes it possible to achieve very high delivered power ratios relative to the weight and the bulk of the fuel cell, that is, that notably allows for cooling by a coolant, in order to render the use of the fuel cell in a motor vehicle significantly easier. The object of the present invention is to refine the metal bipolar plates, because of their great robustness, while eliminating the problem of electrical loss at the second of the two contacts cited hereinabove.

### BRIEF DESCRIPTION OF THE INVENTION

The invention proposes a distribution plate for a fuel cell, consisting of the superposition of a first plate and a second plate, the first plate being made of an electrically conductive material and having an inner face and an outer face designed to cooperate with an ion-exchange membrane, the outer face comprising a network of distribution channels for a first gas, the distribution plate having a second plate made of electrically conductive material having an outer face and having an inner face designed to be applied against the inner face of the first plate, a network of channels for the circulation of a coolant being provided on the inner face either of the first plate or of the second plate, or on both, at least the inner faces of the first and second plates having no surface coating, the plates being joined by a layer of an electrically conductive link material, said layer being attached to the inner face of each of the first and second plates. An appropriate technique for joining the first and second plates is brazing, preferably at high temperature.

The invention obviously applies to bipolar plates, that is, the plates, one side of which forms the anode of a basic electrochemical cell of a fuel cell and the other side of which forms the cathode of an adjacent basic electrochemical cell. However, the invention also applies to the endplates. In practice, the invention applies whenever a distribution plate including an internal network of channels designed to allow a coolant to circulate is to be produced. The rest of the description deals only, but in a nonlimiting way, with bipolar plates, in which the outer face of the second plate is designed to cooperate with an ion-exchange membrane and includes a network of distribution channels for a gas.

Preferably, the electrically conductive material used for the first and second plates is a metallic material. For the layer of electrically conductive link material between first and second plates, a sheet is used that covers all or part of the inner face of each of the first and second plates to produce a braze that provides an excellent electrical contact and that also offers another advantage: it ensures optimum leak-tightness between the coolant circuit and the outside and between the coolant circuit and the gas circuit or circuits.

The invention also extends to a method of manufacturing a steel distribution plate, for a fuel cell, said distribution plate comprising a first plate made of electrically conductive material having an inner face and having an outer face designed to cooperate with an ion-exchange membrane, the distribution plate having a second plate made of electrically conductive material having an outer face and having an inner face designed to be applied against the inner face of the first plate, a network of channels for the circulation of a coolant being provided on the inner face either of the first plate or of the second plate, or of both, consisting in superimposing said first and second plates while inserting a sheet of an electrically conductive link material between them, in heating the assembly obtained to the melting temperature of the link material while maintaining said first and second plates pressed one against the other, in allowing the assembly to cool then in releasing the pressure maintaining the plates to obtain said distribution plate.

The invention allows for the use of stainless steel, a material that is chemically inert to the fluids used, at least on the surface, more specifically at least for the surface in contact with said fluids. In practice, it is very important for the surface of the material not to be attacked by the hydrogen, by the oxygen, by the water that reforms, by any other substance conveyed in the channels, and in particular for the material to remain inert on the surface to the severe conditions that prevail in a fuel cell that is operating.

A bipolar plate is described in detail hereinbelow. Obviously, as already stated, the invention is not limited to bipolar plates; it also extends to the distribution plates positioned on either side of the stack of basic cells.

### BRIEF DESCRIPTION OF THE FIGURES

The present invention will be better understood from the detailed description of an embodiment illustrated with the appended figures in which:

FIG. 1 is an exploded view showing the various component elements of a bipolar plate according to the invention;

FIG. 2 is an exploded view showing, from another viewing angle, the various component elements of a bipolar plate according to the invention;

FIG. 3 is a perspective view showing a bipolar plate according to the invention as it appears when assembled;

FIG. 4 is a perspective view showing, from another viewing angle, a bipolar plate according to the invention as it appears when assembled;

FIG. 5 is an elevation view of one of the outer faces of a bipolar plate according to the invention;

FIG. 6 is a cross section through AA of FIG. 5;

FIG. 7 is an enlargement of the part identified by the circle B in FIG. 6;

FIG. 8 diagrammatically shows a basic electrochemical cell of a fuel cell that uses a distribution plate according to the invention.

### DESCRIPTION OF THE PREFERRED EMBODIMENT OF THE INVENTION

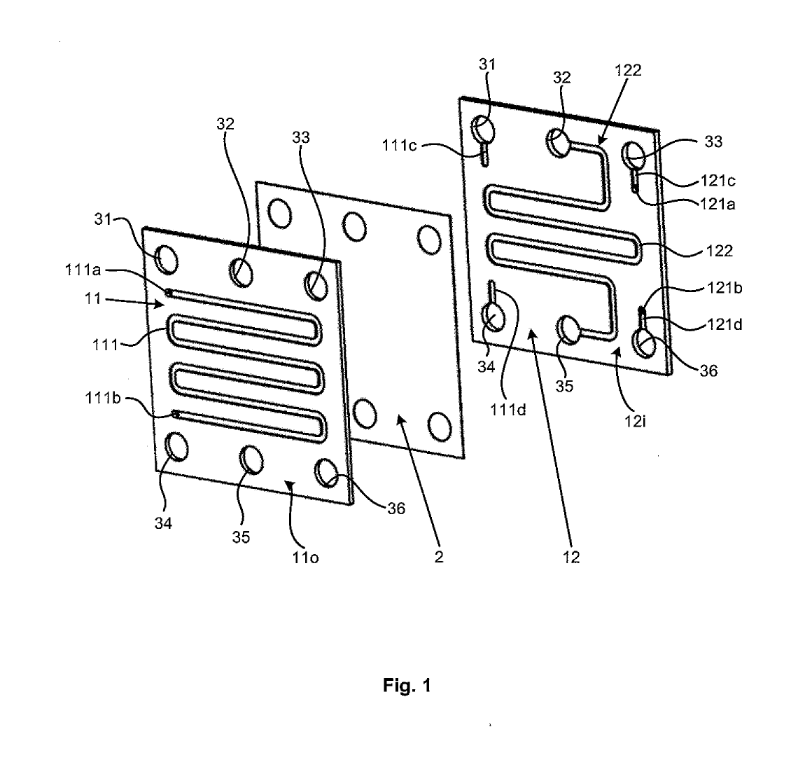

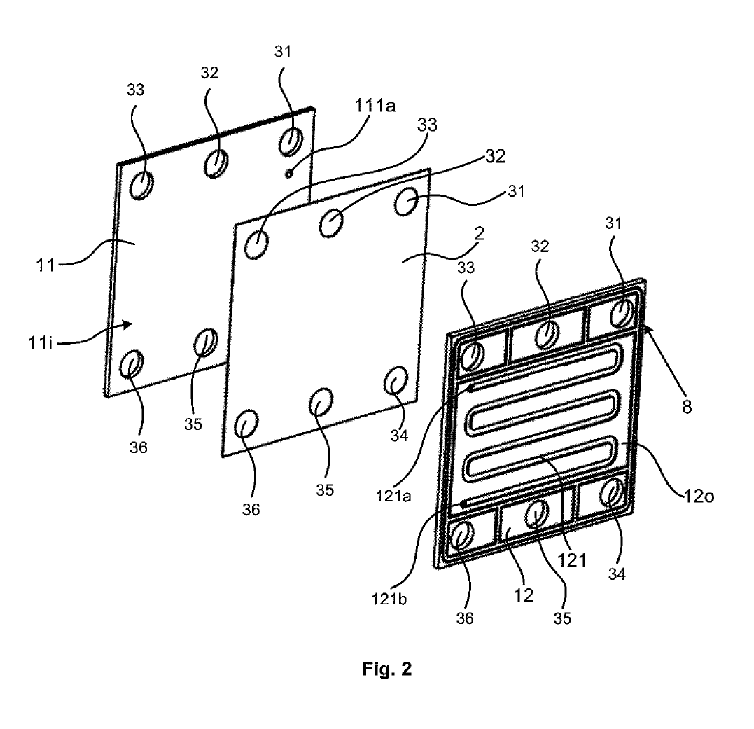

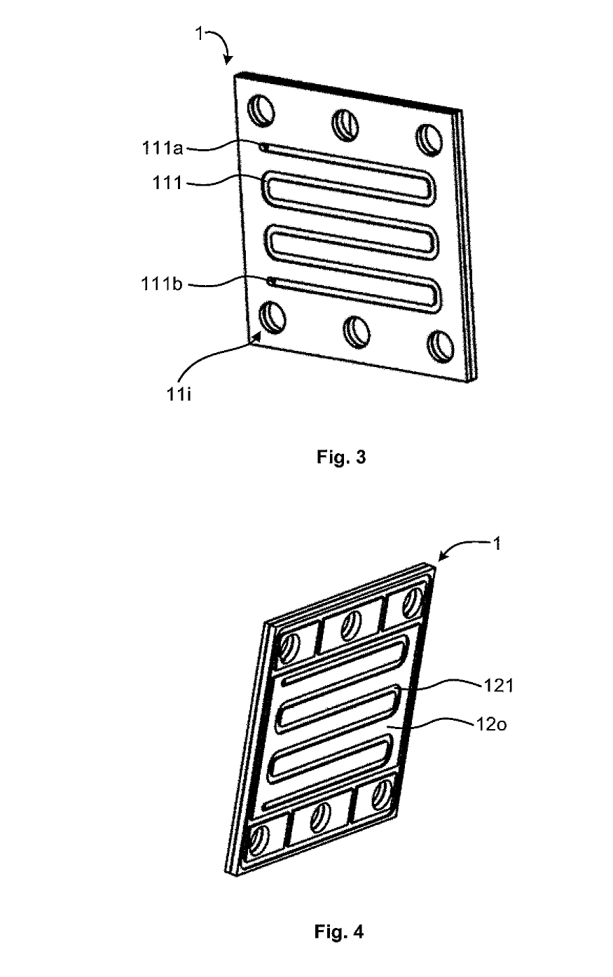

FIGS. 1 and 2 show the component elements of a bipolar plate 1 formed by the assembly of a first plate 11 and a second plate 12. The bipolar plate 1, once assembled, can be seen in FIGS. 3 and 4.

The first plate 11 and the second plate 12 comprise on one side an area showing three openings 31, 32 and 33 of relatively large section, and on the opposite side another area also showing three openings 34, 35 and 36 of relatively large section. All the openings 31 are aligned from one plate 11 to the other 12. Similarly, all the openings 32, respectively 33, 34, 35 and 36, are aligned from one plate 11 to the other 12. The set of openings 31, respectively 33, forms a feed for the routing of one of the gases: one of the openings 31 and 33 (for example 31) routes the hydrogen and the other (for example 33) the oxygen. The set of openings 34, respectively 36, forms a feed for the return of the gases: one of the openings 34 and 36 (34) returns the hydrogen that it not consumed by the cell and the others (36) returns the oxygen that is not consumed by the cell. All the openings 32 form a feed that routes the coolant whereas all the openings 35 form a feed that returns the coolant used to regulate the temperature of the fuel cell.

One of the faces 11o of the first plate 11 comprises a first distribution channel 111 designed to spread over all of the useful section of the first plate 11 one of the two gases used by the fuel cell. The first distribution channel 111 begins with an orifice 111a passing through the thickness of the first plate 11, and ends with an orifice 111b also passing through the first plate 11.

One of the faces 12i of the second plate 12 comprises an internal channel 122, designed to spread over all of the useful section of the second plate 12 the coolant used to regulate the temperature of the fuel cell. The coolant can be a liquid or can be air. In the latter case, the fluid passage section should normally be greater.

The orifice 111a is aligned with the end of a section of channel 111c hollowed out on the face 12i. The orifice 111b is aligned with the end of a section of channel 111d hollowed out on the same face 12i. Each of these sections of channel 111c and 111d communicates with the openings 31 and 34. This ensures communication between the first distribution channel 111 and the feeds concerned.

On the other 12o of these faces, which can be seen in FIG. 2, the second plate 12 has a second distribution channel 121, similar to the distribution channel 111 and also designed to spread over all of the useful section of the second plate 12 the other of the two gases used by the fuel cell. The openings 33 and 36 of the second plate 12 are in communication with, respectively, a section of channel 121c and with a section of channel 121d both hollowed out on the face 12i. Each of the sections of channel 121c and 121d ends with an orifice 121a, respectively 121b, passing through the thickness of the second plate 12, to bring the second channel 121 in communication with the feeds concerned.

We will now look at the production of a braze to permanently link the first and second plates. One advantageous material is stainless steel for the distribution plates. For the braze, nickel or copper is advantageously used (pure nickel or copper, preferably pure—pure should be understood to mean, as is well known to those skilled in the art, containing more than 99% of the element concerned—or a copper-based alloy or a nickel-based alloy). The following alloys are given purely as examples: Cu—P (approximately 95% copper, the balance phosphorus), Ni—P (89% Ni and 11% P), Ni—Cr—Si (71% Ni, 19% Cr and 10% Si), Ni—B—Cr—Fe—Si (74% Ni, 3% B, 14% Cr, 4.5% Fe and 4.5% Si).

The material for the braze is used in paste form or preferably in the form of a sheet. The brazing sheet is cut to the dimensions of the first and second plates. An assembly is produced formed by the first plate 11, the second plate 12, with a brazing sheet 12 inserted between them. The thickness of this brazing sheet is chosen to be such that the braze, on the one hand, provides a very uniform electrical contact between the first and second plates, and, on the other hand, guarantees perfect leak-tightness without preventing the effective circulation of the coolant. A typical, but nonlimiting, thickness of this sheet is of the order of a hundredth of a millimetre. Remember that the inner faces 11i and 12i of the first and second plates have no surface coating.

This assembly is heated at least to the melting temperature of the brazing metal. Typically, this temperature is exceeded by around 10° C. to 20° C. to be sure that all of the brazing sheet changes to liquid phase. Obviously, the exact temperature depends on the material selected for the braze. After cooling, a bipolar plate 1 is obtained that comprises on one face, channels 111, for example for the anode gas circuit, on the other face, channels 121, in this example for the cathode gas circuit, and between the plates, channels 122, which cannot be seen after assembly, for the coolant circuit.

Preferably, the assembly obtained is heated in an inert gas atmosphere (nitrogen for example) to a temperature level below the melting temperature of the material (for example of the order of 800° C. for brazing with pure copper). Then, a vacuum is formed to continue raising the temperature, to approximately 1100° C. for a braze with pure copper. Preferably again, after the phase of raising the temperature to beyond the melting temperature of the link material, the assembly is left to cool in a vacuum to a temperature level below the melting temperature of the material (for example, the same temperature level as when raising the temperature), and the cooling is continued in an inert gas atmosphere (for example nitrogen).

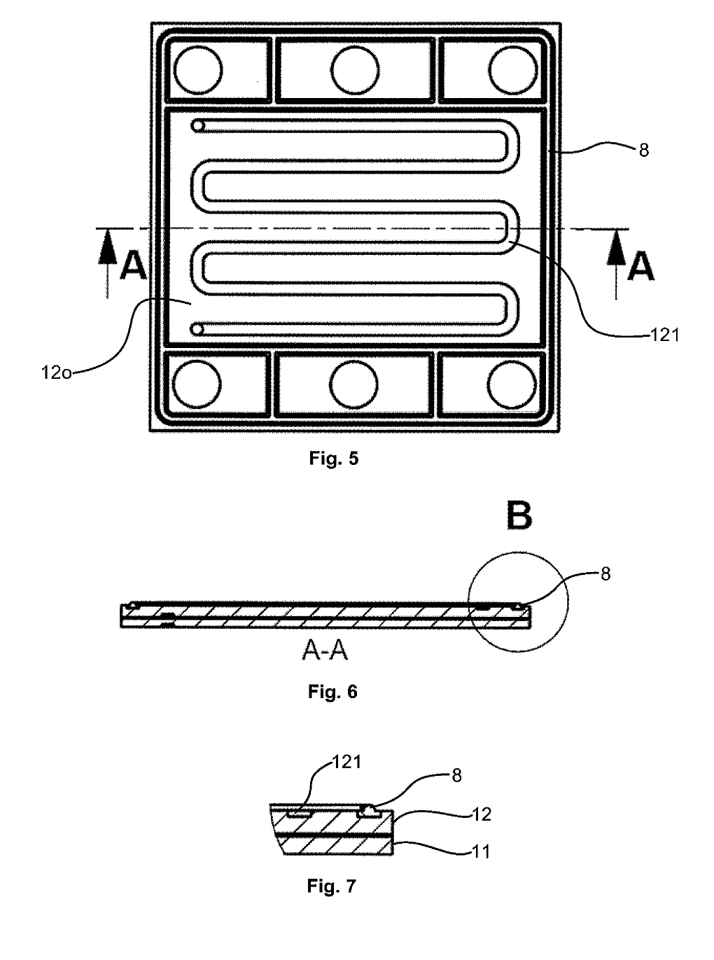

The electrical contact between plates assembled in this way is excellent. Also, there is no need to provide a seal within the bipolar plate itself, that is, between the two distribution plates 11 and 12. Only a seal 8 between a bipolar plate and an ion-exchange membrane is necessary. FIGS. 5, 6 and 7 show the layout of such a seal. In particular, the enlarged view of FIG. 7 shows the arrangement of such a seal in cross section.

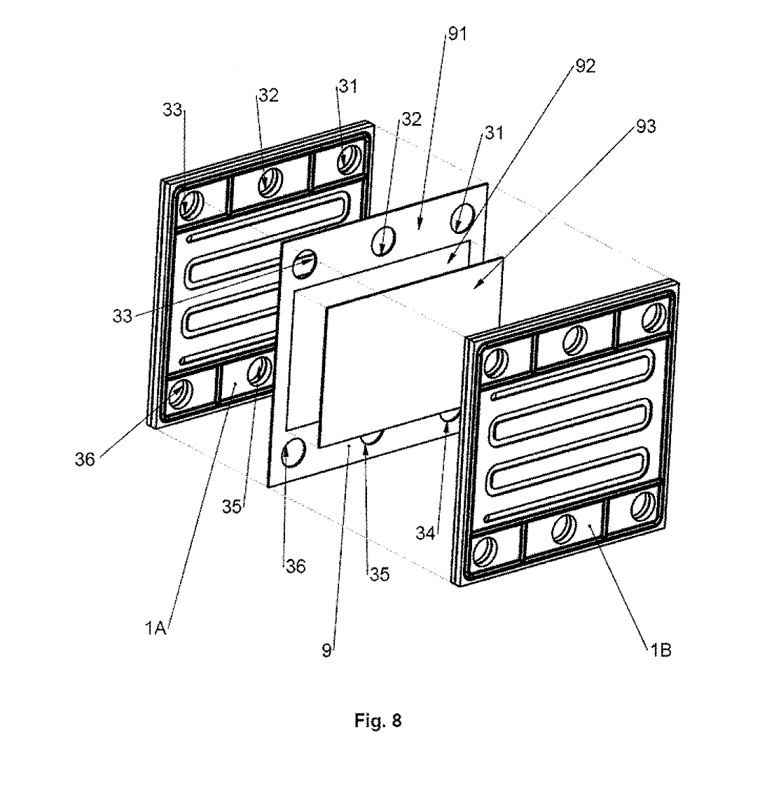

A bipolar plate according to the invention is designed to be associated with elements forming an electrochemical cell. FIG. 8 shows an electrochemical cell 9 associated with two identical bipolar plates 1A and 1B. It is known that a basic electrochemical cell 9 is currently (without this in any way limiting the invention) usually made up of the superposition of five layers: an ion-exchange polymer membrane 91, two electrodes 92 (just one visible in the drawing) comprising chemical elements necessary to the progress of the electrochemical reaction, such as, for example, platinum, and two gas diffusion layers 93 (just one visible in the drawing) for ensuring a uniform diffusion of the gases routed by the networks of channels in the bipolar plates over all the surface of the ion-exchange membrane.

Openings 31, respectively 32, 33, 34, 35 and 36 are also provided on the polymer membranes 91 and are aligned with the openings of the distribution plates. Each of the faces 11o and 12o of the bipolar plates can cooperate with one of the diffusion layers of the adjacent electrochemical cells 9. A large number of electrochemical cells 9 are superimposed with bipolar plates 1 inserted between, and simple (non-bipolar) distribution plates are arranged at the ends to form a fuel cell.

Thus as a result of the invention, it is possible to choose, for the basic constituent material of each of the individual plates, an electrically conductive material that offers mechanical characteristics that are sufficient to allow not only the service stresses for the fuel cell to be transmitted, but also to allow the manufacture of the bipolar plates to be automated. In practice, such an automation presupposes production robot handling and if such handling requires little in the way of precautions thanks to the solidity of the constituent material of the basic plates, automatic production can only be simpler, more robust and more cost effective to implement.

1. A distribution plate for a fuel cell, comprising a superposed arrangement of a first plate and a second plate, the first plate being made of an electrically conductive material and having an inner face and an outer face adapted to cooperate with an ion-exchange membrane, the outer face comprising a network of distribution channels for a first gas, the second plate being made of an electrically conductive material and having an outer face and an inner face adapted to be applied against the inner face of the first plate, a network of channels for the circulation of a coolant being provided on the inner face either of the first plate or of the second plate, or on both, at least the inner faces of the first and second plates having no surface coating, the plates being joined by a layer of an electrically conductive link material, said layer being attached to the inner face of each of the first and second plates.

2. The distribution plate according to claim 1, forming a bipolar plate, wherein the outer face of the second plate is configured to cooperate with an ion-exchange membrane and includes a network of distribution channels for a second gas.

3. The distribution plate according to claim 1, wherein said first and second plates are made of metallic material.

4. The distribution plate according to claim 3, wherein said first and second plates are made of stainless steel.

5. The distribution plate according to claim 1, wherein the link material is an alloy chosen from the list formed by copper-based alloys and nickel-based alloys.

6. The distribution plate according to claim 1, wherein the link material is chosen from the list formed by pure copper and pure nickel.

7. A method of manufacturing a steel distribution plate, for a fuel cell, said distribution plate comprising a first plate made of electrically conductive material having an inner face and having an outer face adapted to cooperate with an ion-exchange membrane, the distribution plate having a second plate made of electrically conductive material having an outer face and having an inner face adapted to be applied against the inner face of the first plate, a network of channels for the circulation of a coolant being provided on the inner face either of the first plate or of the second plate, or of both, wherein the method comprises the steps of:
superposing said first and second plates while inserting a sheet of an electrically conductive link material between them;
heating the assembly obtained just beyond the melting temperature of the link material while maintaining said first and second plates pressed one against the other;
leaving the assembly to cool, and then releasing the pressure maintaining the plates to obtain said distribution plate.

8. The method according to claim 7, wherein said first and second plates are made of stainless steel.

9. The method according to claim 7, wherein the link material is a copper-based alloy.

10. The method according to claim 7, wherein the link material is made of pure copper.

11. The method according to claim 7, wherein the assembly obtained is heated in an inert gas atmosphere to a temperature level below the melting temperature of the link material, and a vacuum is formed to continue raising the temperature.

12. The method according to claim 11, wherein, after the phase of raising the temperature to beyond the melting temperature of the link material, the assembly is left to cool in a vacuum to a temperature level below the melting temperature of the link material, and the cooling is continued in an inert gas atmosphere.
